(19) United States
(12) Patent Application Publication
(10) Pub. No.: US 2025/0162405 A1
(43) Pub. Date: May 22, 2025

(54) Loading, Tank or Service Flap

(71) Applicant: Illinois Tool Works Inc., Glenview, IL (US)

(72) Inventors: Sebastian ÖFFNER, Güntersleben (DE); Erik DILJE, Würzburg (DE)

(21) Appl. No.: 18/939,865

(22) Filed: Nov. 7, 2024

(30) Foreign Application Priority Data
Nov. 17, 2023 (DE) 10 2023 132 142.0

(51) Int. Cl. B60K 15/05; B60L 53/16

(52) U.S. Cl. CPC B60K 15/05; B60L 53/16; B60K 2015/0515

(57) ABSTRACT

The present disclosure relates to a charging, fueling, or service flap (100). The charging, fueling, or service flap (100) is reversibly movable, and in particular pivotable, by way of an actuator between a closed position and an open position relative to the charging, fueling, or service compartment. The charging, fueling, or service flap (100) includes a carrier (102) that can be pivotally attached to a charging, fueling, or service compartment; and an actuating apparatus (104) having an actuator (108), which covers the carrier (102) at least partially, in particular over its full surface, wherein the actuator (108) can be moved relative to the carrier (102) between a resting position and an actuation position to generate an actuation signal for opening or closing the charging, fueling, or service flap (100) when the actuator (108) is moved into the actuation position.

### RELATED APPLICATION

The present application claims the benefit of German Patent Application No. 10 2023 132 142.0, filed Nov. 17, 2023, titled “Loading, Tank or Service Flap,” the contents of which are hereby incorporated by reference.

### BACKGROUND

Vehicles with a hybrid or electromotive drive usually have one battery or traction battery, which, for example in the case of PHEV vehicles (PHEV=plug-in hybrid electric vehicle) or BEV vehicles (BEV=battery electric vehicle), can be charged via an electrical charging port that is accessible from the outside on the vehicle body, and is typically a charging port, by connecting to an electrical charging station, for example, or a conventional external electrical port.

The charging port is usually arranged in a charging compartment of the vehicle body, which is covered or closed by a charging flap or a charging closure element. A mechanism that cooperates with the charging flap or charging closure element selectively allows the charging compartment to be opened and closed or the charging flap or charging closure element to be flipped open and closed in relation to the charging compartment, and thus allows access to the charging port.

In vehicles with a combustion-based drive, a fuel tank is supplied with fuel via a tank filler-neck, which is accessible from the outside by connection to a fuel pump or a fuel nozzle, for example. Like the charging port, the filler neck is typically arranged in a filler neck housing that is associated with the vehicle body and is covered or closed by a fueling flap or a tank closure element. Here, too, a mechanism that cooperates with the fueling flap or tank closure element selectively allows the fueling compartment to be opened and closed or the fueling flap or tank closure element to be flipped open and closed in relation to the fueling compartment, and thus allows access to the tank filler-neck.

The terms “fueling flap” and “fueling compartment” as used herein are not understood to mean only the components associated with a fueling or the components necessary for filling a fuel tank. Rather, these terms are also intended to include components for a tank for receiving other resources, for example AdBlue or urea, or an additive such as water. Accordingly, the disclosure also relates to actuating mechanisms for actuating service flaps associated with a filling system for a resource or additive fueling, in particular a fuel, AdBlue, or water tank.

In the prior art, there is a fundamental need for charging, fueling, or service flaps that are intuitively and reliably actuatable. Also, the charging, fueling, or service flaps must minimally affect the exterior appearance of the vehicle.

Based on this, the problem addressed by the disclosure is to specify a charging, fueling, or service flap which is easy to actuate and has a substantially identical outer surface to the vehicle outer shell.

### SUMMARY

The present disclosure relates generally to a charging flap, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a perspective rear view of a charging flap 100 according to one aspect of the present disclosure.

FIGS. 2 and 3 illustrate longitudinal section and cross-section views through the charging flap according to FIG. 1.

FIG. 4 illustrates an enlarged view of the first projection of the actuating apparatus of the charging flap according to FIG. 1.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a charging, fueling, or service flap for covering a charging, fueling, or service compartment that is or can be received at or in a housing of a vehicle. Further aspects of the present disclosure relate to a charging, fueling, or service assembly or a vehicle having such a charging, fueling, or service flap.

This underlying problem of the disclosure is solved in particular by the subject matter of the independent claim 1, wherein advantageous further developments of the charging, fueling, or service flap according to the disclosure are specified in the dependent claims.

Accordingly, the disclosure relates to a charging, fueling, or service flap for covering a charging, fueling, or service compartment that is or can be received on or in a housing, in particular a body component of a vehicle, wherein the charging, fueling, or service flap is reversibly movable, and in particular pivotable, by way of an actuator between a closed position and an open position relative to the charging, fueling, or service compartment, and wherein the charging, fueling, or service flap comprises the following: a carrier that can be pivotally attached to a charging, fueling, or service compartment; an actuating apparatus having an actuating means, which, when installed, is arranged on a side of the carrier facing away from the charging, fueling, or service compartment and covers the carrier at least partially, in particular over its full surface, wherein the actuating means can be moved relative to the carrier between a resting position and an actuation position to generate an actuation signal for opening or closing the charging, fueling, or service flap when the actuating means is moved into the actuation position.

The relative movement of the actuating means in relation to the carrier between the resting position and the actuation position can be detected by a sensor or a switch to generate the actuation signal to drive the actuator. According to the present disclosure, it is not necessary for the carrier to be movable itself when it is in the resting position. Rather, the carrier of the charging, fueling, or service flap according to the disclosure can be moved exclusively by the actuator, but not manually. As a result, complicated kinematics connecting the carrier to the actuator can be omitted.

The actuating means can in particular be configured as a cover of the carrier. The cover can have an outer surface substantially corresponding to the vehicle outer shell, such that the charging, fueling, or service flap according to the disclosure only negligibly changes the appearance of the vehicle. Accordingly, the actuating means is not to be recognized as such on the exterior of the vehicle. Rather, it is configured as a cover that can be pressed in relative to the carrier.

According to a further aspect, the actuating apparatus comprises a first projection extending from a surface of the actuating means facing the carrier. The first projection can be used to actuate a sensor or switch as described above. With the inwardly extending projection, the switch or sensor can be even further spaced apart from the vehicle's outer shell, i.e., the outer surface of the actuating means, to protect it against environmental influences.

According to a further aspect, the carrier comprises an opening extending between a surface facing the actuating means and a surface facing away from the actuating means, and wherein the first projection of the actuating apparatus extends into the opening, in particular through the opening, at least in the actuation position of the actuating means. According to this design variant, the switch or sensor can be arranged within the carrier or even within a corresponding charging, fueling, or service compartment, so that it can be protected even better against environmental influences.

According to a further aspect, the charging, fueling, or service flap comprises a biasing element, in particular a spring element, which is configured to bias the actuating means into the resting position. Accordingly, after activation of the actuating means, it is automatically transferred back into its home position, so that it is preferably arranged flush with the outer shell of the vehicle again.

According to a further aspect, the biasing element comprises at least one elastic portion arranged in the carrier and configured to elastically deform when the actuating means is transferred into the actuation position. For example, the elastic portion can be one or more cantilevers arranged in the carrier. These can be produced by parallel or U-shaped cutouts, for example, as will be explained in further detail later below.

According to a further aspect, the biasing element comprises a second projection extending from a surface of the actuating means facing the carrier and being configured to deform the elastic portion of the carrier when the actuating means is transferred into the actuation position.

According to a further aspect, the actuating means is clipped to the carrier. The actuating means can in particular be releasably clipped to the carrier. Accordingly, the actuating means and the carrier can be produced separately. According to this aspect, the actuating means can also be replaced very simply if, for example, damage to the actuating means occurs. This is also particularly advantageous when the actuating means is configured as a cover of the carrier, because, in this case, it can be provided in particular that the actuating means is designed as a metal cover while the carrier is made of plastic.

A further aspect of the present disclosure relates to a charging, fueling, or service assembly for a vehicle, comprising the following: a charging, fueling, or service compartment that is or can be received on a housing of the vehicle, in particular a body element of the vehicle; a charging, fueling, or service flap, wherein the charging, fueling, or service flap can be moved, and in particular pivoted, by way of an actuator relative to the charging, fueling, or service compartment reversibly between the closed position and the open position; and a switch or sensor configured to sense a relative movement of the actuating means in relation to the carrier and to generate an actuation signal for opening or closing the charging, fueling, or service flap when the actuating means is transferred into its actuation position.

According to a further aspect, the switch or sensor is arranged in the charging, fueling, or service compartment. As already mentioned above, the switch or sensor can thereby be particularly effectively protected against environmental influences.

A further aspect of the present disclosure relates to a vehicle having a charging, fueling, or service flap as mentioned above, wherein an exterior of the actuating means, in the resting position of the actuating means, is arranged flush with an outer shell of the vehicle.

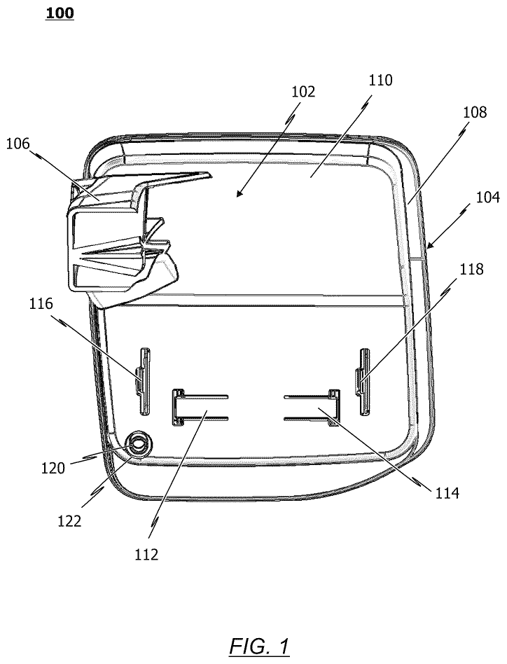

FIGS. 1 to 4 provide views of a charging flap 100 according to one aspect of the present disclosure. Although in the exemplary aspect according to FIGS. 1 to 4 it is a charging flap 100, it should be noted that the present disclosure is not limited to charging flaps. Rather, the carrier and actuating apparatus shown herein can also be applied in the case of service or fueling flaps.

The charging flap 100 is shown in a rear perspective view in FIG. 1. The charging flap 100 comprises a carrier 102 that can be pivotally attached to a corresponding charging compartment. For this purpose, a pivot arm 106 attached to a rear side 110 of the carrier 102 is pivotally connected to the charging compartment. A pivoting of the carrier 102 in relation to the charging compartment is possible in particular due to an actuator, which is not shown herein. This actuator can pivot the carrier to move the charging flap 100 between a closed position and an open position relative to the charging compartment. The disclosure is also not limited to a pivoting of the charging flap 100. Rather, any automatically performed movement (i.e., by way of an actuator) of the charging flap can be activated by the present disclosure for the purpose of opening or closing. Accordingly, in aspects not shown herein, the carrier can also be slidable in relation to the charging compartment.

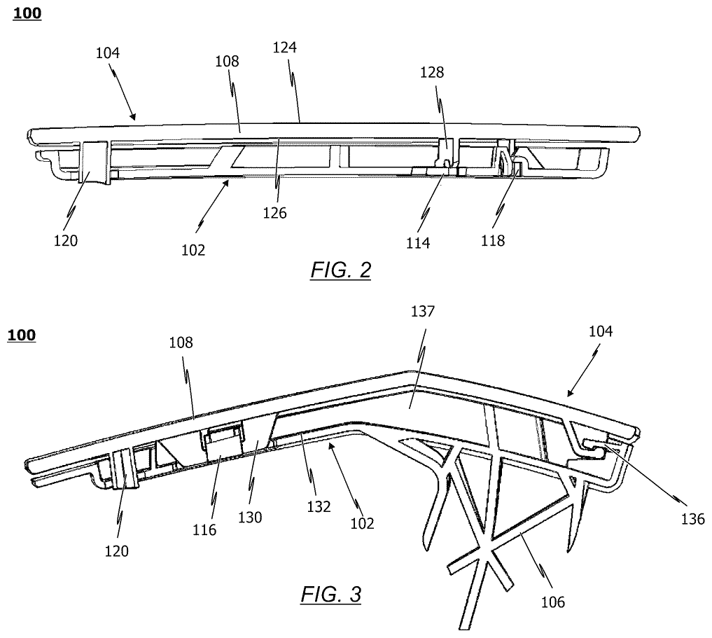

The charging flap 100 further comprises an actuating apparatus 104. The actuating apparatus 104 comprises an actuating means 108 arranged on a side of the carrier (132, FIG. 3) facing away from the charging compartment. The actuating means 108 according to the figures shown herein covers the carrier 102 over its full surface. In other words, the actuating means 108 is designed as a cover that extends beyond the outer circumference of the carrier. A surface (124, FIG. 2) facing away from the carrier is visible on the exterior of the vehicle. The carrier 102 itself is covered by the actuating means 108, so that the carrier 102, in the closed position of the charging flap 100, is not visible from the outside.

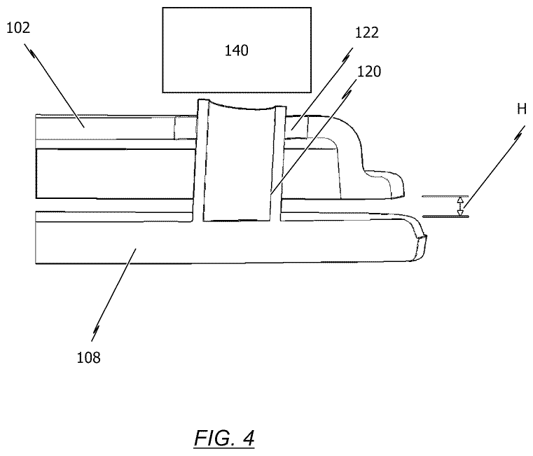

The actuating means 108 of the actuating apparatus 104 can be moved relative to the carrier 102. In particular, reference is made to the illustration according to FIG. 3. The actuating means 108 can be moved from the resting position shown in FIG. 3 towards the carrier element 102. This can be accomplished in particular by pushing on the surface 124 of the actuating means 108 facing away from the carrier 102. This pivots the actuating means 108 in particular about a pivot axis 136, thereby reducing a distance H (FIG. 4) between the actuating means 108 and the carrier 102.

As will be explained in further detail below, such a relative movement of the actuating means 108 in relation to the carrier serves to generate an actuation signal to drive the actuator (not shown). In the aspect shown in the figures, a first projection 120 attached to the actuating means 108 serves to detect a relative movement of the actuating means 108 in relation to the carrier 102. The first projection 120 is configured as a tappet in this case, but of course it can have any other shape. The first projection 120 is guided during the relative movement in an opening 122 of the carrier 102. In an exemplary aspect shown in FIG. 4, the first projection 120 serves in particular to actuate a switch 140 when the actuating means 108 is transferred from its resting position shown in the figures into the actuation position. In particular, the first projection 120 is pushed through the opening 122 of the carrier 102 and can operate the switch 140 with its distal end. The switch 140 can consequently generate an actuation signal for opening the charging flap, which is passed to the actuator.

In an alternative configuration, the switch 140 can also be arranged otherwise. For example, it can be received in the carrier 102. Alternatively, or in addition to the switch, a sensor can also be provided, which senses the relative movement of the actuating means, and in particular the first projection 120, in relation to the carrier 102. Such sensors can also be arranged within the carrier 102, e.g., in a cavity 137 of the carrier, or in the charging compartment (not shown).

The actuating means 108 is biased into the resting position shown in the figures. For this purpose, the charging flap 100 comprises biasing elements configured to automatically return the actuating means 108 to the resting position upon generation of the actuation signal. In the aspect illustrated herein, the biasing elements are configured as spring elements having two elastic portions 112, 114 on the carrier 102. For example, the elastic portions 112, 114 are shown in FIG. 1. These are cantilevers that are implemented by U-shaped cutouts in the carrier 102. On the side of the actuating apparatus 104, the biasing element can comprise second projections 128 extending from a surface 126 of the actuating means 108 facing the carrier and being configured to deform the elastic portions 112, 114 of the carrier 102 when the actuating means 108 is transferred into the actuating position.

FIGS. 1 and 3 further show that the actuating apparatus 104 is releasably clipped to the carrier 102. For this purpose, the carrier comprises snap connectors 116, 118, which cooperate with snap hooks 130 of the actuating apparatus 104 to fasten the actuating apparatus 104 to the carrier 102.

The above-cited patents and patent publications are hereby incorporated by reference in their entirety. While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A charging, fueling, or service flap (100) for covering a charging, fueling, or service compartment that is or can be received on or in a body component of a vehicle, wherein the charging, fueling, or service flap (100) is reversibly pivotable by way of an actuator between a closed position and an open position relative to the charging, fueling, or service compartment, and wherein the charging, fueling, or service flap (100) comprises:
a carrier (102) that can be pivotally attached to a charging, fueling, or service compartment; and
an actuating apparatus (104) having an actuator (108), which, when installed, is arranged on a side of the carrier (102) facing away from the charging, fueling, or service compartment and covers the carrier (102) at least partially,
wherein the actuator (108) can be moved relative to the carrier (102) between a resting position and an actuation position to generate an actuation signal for opening or closing the charging, fueling, or service flap (100) when the actuator (108) is moved into the actuation position.

2. The charging, fueling, or service flap (100) according to claim 1, wherein the actuating apparatus (104) comprises a first projection (120) extending from a surface of the actuator (108) facing the carrier (102).

3. The charging, fueling, or service flap (100) according to claim 2, wherein the carrier (102) comprises an opening (122) extending between a surface facing the actuator (108) and a surface facing away from the actuator (108), and wherein the first projection (120) of the actuating apparatus (104) extends into the opening (122), in particular through the opening, at least in the actuation position of the actuator (108).

4. The charging, fueling, or service flap (100) according to claim 1, wherein the charging, fueling, or service flap (100) comprises a spring element configured to bias the actuator (108) into the resting position.

5. The charging, fueling, or service flap (100) according to claim 4, wherein the biasing element comprises at least one elastic portion (116, 118) arranged in the carrier (102) and configured to elastically deform when the actuator (108) is transferred into the actuation position.

6. The charging, fueling, or service flap (100) according to claim 5, wherein the biasing element comprises a second projection (128) extending from a surface (126) of the actuator (108) facing the carrier (102) and being configured to deform the elastic portion of the carrier (102) when the actuator (108) is transferred into the actuation position.

7. The charging, fueling, or service flap (100) according to claim 1, wherein the actuating apparatus (104) is clipped, preferably releasably, to the carrier (102).

8. A charging, fueling, or service assembly for a vehicle, comprising the following:
a charging, fueling, or service compartment that is or can be received on a housing of the vehicle, in particular a body element of the vehicle;
a charging, fueling, or service flap (100) according to claim 1, wherein the charging, fueling, or service flap (100) can be pivoted by way of an actuator relative to the charging, fueling, or service compartment reversibly between the closed position and the open position; and
a switch (140) or sensor configured to sense a relative movement of the actuator (108) in relation to the carrier (102) and to generate an actuation signal for opening or closing the charging, fueling, or service flap (100) when the actuator (108) is transferred into its actuation position.

9. The charging, fueling, or service assembly according to claim 8, wherein the switch (140) or sensor is arranged in the charging, fueling, or service compartment or in the carrier (102).

10. A vehicle having a charging, fueling, or service flap (100) according to claim 1, wherein an exterior (124) of the actuator (108), in the resting position of the actuator (108), is arranged flush with an outer shell of the vehicle.
